(19) United States
(12) Patent Application Publication
(10) Pub. No.: US 2014/0299504 A1
(43) Pub. Date: Oct. 9, 2014

(54) MEDICATION TRACKING APPARATUS

(71) Applicant: Richard J. Sena, Rockfall, CT (US)

(72) Inventor: Richard J. Sena, Rockfall, CT (US)

(21) Appl. No.: 14/247,888

(22) Filed: Apr. 8, 2014

Related U.S. Application Data
(60) Provisional application No. 61/809,945, filed on Apr. 9, 2013.

(51) Int. Cl. A61J 1/03

(52) U.S. Cl. CPC A61J 1/03
USPC 206/534

(57) ABSTRACT

A medication tracking apparatus that includes a housing, a day manipulation disk and a time display disk is provided. The housing has at least one window. The day manipulation disk includes day information and is rotationally coupled within the housing. The day manipulation disk is further configured and arranged to be manually rotated to display a select day from the day information in the at least one window of the housing. The time display disk includes time information and is rotationally coupled within the housing. The time display disk is further configured and arranged to be manually rotated to display a select time from the time information in the at least one window of the housing.

### CROSS-REFERENCE TO RELATED APPLICATIONS

This Application claims benefit and priority to U.S. Provisional Application Ser. No. 61/809,945, same title herewith, filed on Apr. 9, 2013, which is incorporated in its entirety herein by reference.

### BACKGROUND

Remembering if and when a medication has been taken can be an issue. For example, if the medication is to be repeatedly taken on a daily basis for a significant number of days it can become difficult to remember if the medication was already taken on a given day or whether it was a memory of taking the medication on a prior day.

For the reasons stated above and for other reasons stated below which will become apparent to those skilled in the art upon reading and understanding the present specification, there is a need in the art for an effective and efficient apparatus that indicates when a medication has last been taken.

### SUMMARY OF INVENTION

The above-mentioned problems of current systems are addressed by embodiments of the present invention and will be understood by reading and studying the following specification. The following summary is made by way of example and not by way of limitation. It is merely provided to aid the reader in understanding some of the aspects of the invention.

In one embodiment, a medication tracking apparatus is provided. The medication tracking apparatus includes a housing, a day manipulation disk and a time display disk. The housing has at least one window. The day manipulation disk includes day information and is rotationally coupled within the housing. The day manipulation disk is further configured and arranged to be manually rotated to display a select day from the day information in the at least one window of the housing. The time display disk includes time information and is rotationally coupled within the housing. The time display disk is further configured and arranged to be manually rotated to display a select time from the time information disk in the at least one window of the housing.

In another embodiment, another medication tracking apparatus is provided. This medication tracking apparatus includes a housing, a day manipulation disk and a time display disk. The housing is generally disk shaped having a front side, a back side and a side edge. The housing further has a day window and a time window through the front side. The housing also includes a day manipulation aperture and a time manipulation aperture through the side edge of the housing. The day manipulation disk is received within the housing. The day manipulation disk includes day information that is selectively displayed through the day window. The day manipulation aperture allows access to manipulate the day manipulation disk. The time display disk is also received within the housing. The time display disk includes day information that is selectively displayed through the time window. The time manipulation aperture allows access to manipulate the time manipulation disk.

In still another embodiment, another medication tracking apparatus is provided. This medication tracking apparatus includes a housing, a day manipulation disk, a time display disk, a time position holding assembly and a day position holding assembly. The housing is generally disk shaped having a front side, a back side and a side edge. The housing has a day window and a time window through the front side. The housing further includes a day manipulation aperture and a time manipulation aperture through the side edge of the housing. The day manipulation disk is received within the housing. The day manipulation disk includes day information that is selectively displayed through the day window. The day manipulation aperture allows access to manipulate the day manipulation disk by a user. The time display disk is received within the housing. The time display disk includes day information that is selectively displayed through the time window. The time manipulation aperture allows access to manipulate the time manipulation disk by the user. The time position holding assembly is configured and arranged to hold the time display disk in a static position in relation to the housing when the time display disk is not being manipulated by the user. The day position holding assembly is configured and arranged to hold the day manipulation disk in a static position in relation to the housing when the day manipulation disk is not being manipulated by the user.

### BRIEF DESCRIPTION OF THE DRAWINGS

The present invention can be more easily understood and further advantages and uses thereof will be more readily apparent, when considered in view of the detailed description and the following figures in which:

FIG. 1 is a side perspective view of a medication tracking apparatus attached to a medication holding device of an embodiment of the present invention;

FIG. 2 is a front view of the medication tracking apparatus of one embodiment of the present invention;

FIG. 3 is a front-first side perspective view of the medication tracking apparatus of FIG. 2;

FIG. 4 is a front-second side perspective view of the medication tracking apparatus of FIG. 2;

FIG. 5 is a back perspective view of the medication tracking apparatus of FIG. 2;

FIG. 6 is a front view of a medication tracking apparatus without part of its housing of one embodiment of the present invention; and

FIG. 7 is a front view of a medication tracking apparatus without part of its housing of another embodiment of the present invention.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a non-electrical simple apparatus that tracks when a last medication was taken or when the next medication is to be taken. In some embodiments, the apparatus is designed to be attached to a medication holding device such as, but not limited to, a bottle or blister pack. In one embodiment, the apparatus is disk shaped. Moreover in embodiments the apparatus includes rotating disks (wheels, clogs) that are manually “clicked” into place in relation to a housing. In an embodiment one disk is designed to display day information such as the day of the week while another disk is designed to display time information such as the time of the day. The time of the day can be displayed as an hour, a half-hour, a quarter hour, etc. Information on the disks taken together display the day and time the medication was last taken or is to be taken. More than two disks (wheels) can be used to display the desired time and day. That is, any number of disks (wheels) can be used to convey the desired information through windows in the housing.

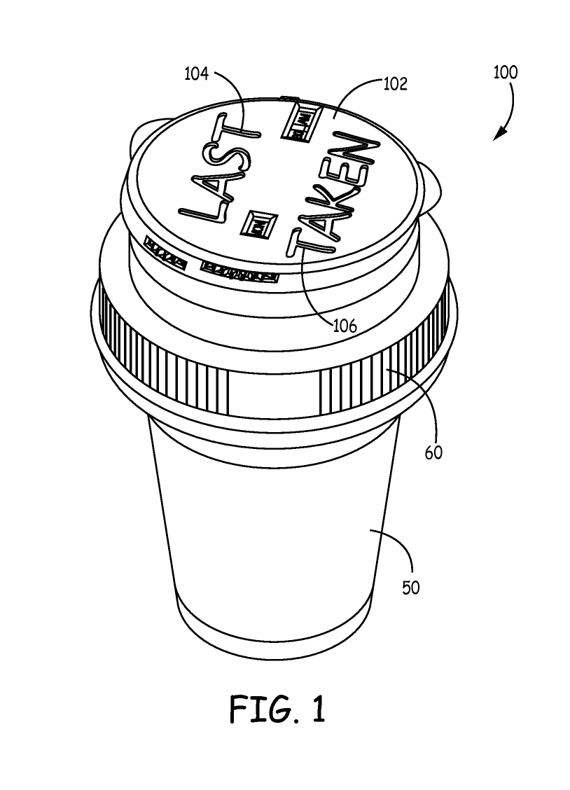

In embodiments, the select rotation of the disks allows the user to change the displayed day and time to reflect the desired information. The housing containing the disks is designed to be coupled to a medication holding device such as a bottle or blister pack. In one embodiment an adhesive is used to couple the apparatus to the medication dispensing housing. Referring to FIG. 1, an example of a medication tracking apparatus 100 of an embodiment of the present invention is illustrated. In this embodiment the housing 102 is marked with “Last Taken” 104, 106 that indicates the information provided relates to the last time the medication was taken. In other embodiments the information may be different. For example, the information may indicate when to take the next dose of the medication such as a marking that states “Next Dose.” In FIG. 1, the medication tracking apparatus is coupled to a cap 60 of a pill bottle 50. The information provided in FIG. 1 indicates the medication was “Last Taken” on Monday at 9 AM.

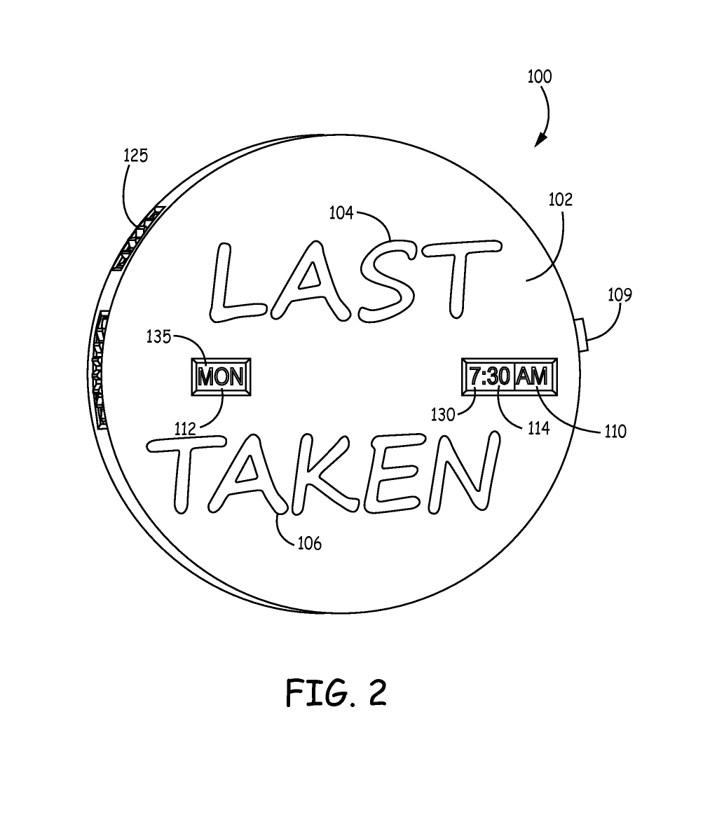

Referring to FIG. 2, a front view of the medication tracking apparatus 100 unattached to a medication holding device is illustrated. In this embodiment the writing 104 and 106 (or marking) indicated when the medication was “Last Taken.” As illustrated, the housing 102 includes a day window 112, a time window 114 and an AM/PM window 110. Within the day window 112, day information that is marked on a day manipulation disk 135 is shown. As discussed further below, the day manipulation disk 135 is manipulated to display a select day within the day window 112. Within the time window 114 time information on a time display disk 130 is shown. Here again, as discussed further below, the time display disk 130 is manipulated to display a select time. Within the AM/PM window 110 is shown an indication whether the select time is an “AM” time or a “PM” time. As illustrated, in this embodiment the housing 102 is generally disk shaped.

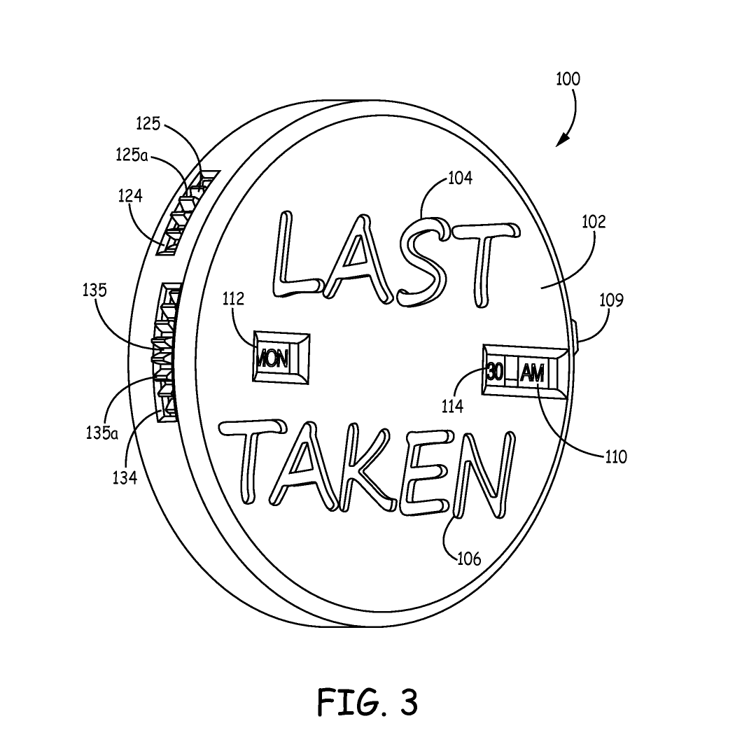

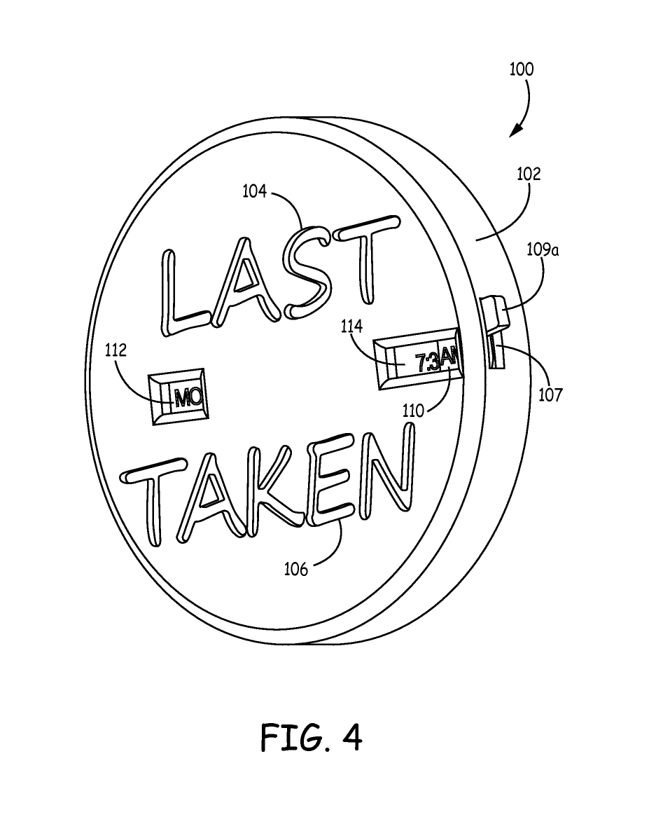

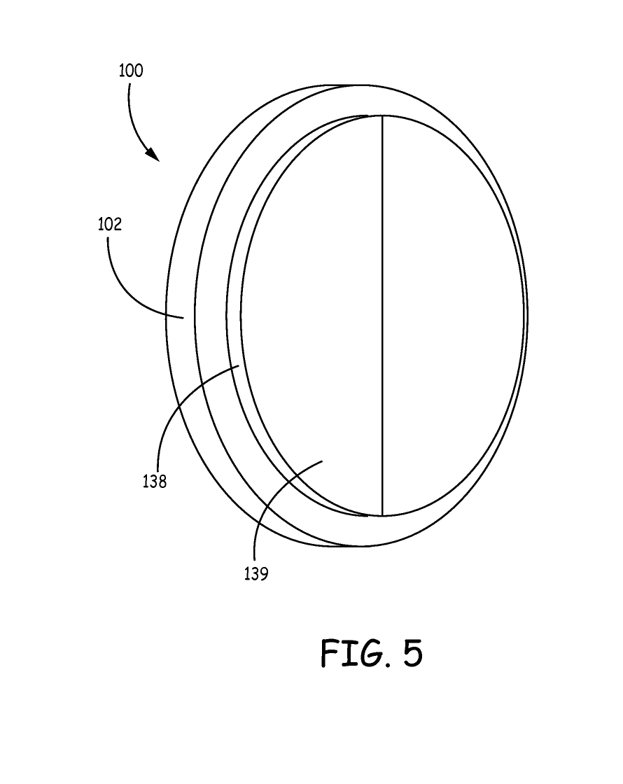

FIG. 3 illustrates a front-first side perspective view of the medication tracking apparatus 100. This view illustrates a time manipulation aperture 124 and a day manipulation aperture 134 in a first side of a side edge of the housing 102. Also illustrated are time manipulation teeth 125a of a time manipulation disk 125 (described further in detail below) that extend through the time manipulation aperture 124. This configuration allows access to manipulate the time manipulation disk 125 with a user's finger. Similarly, day manipulation teeth 135a of the day manipulation disk 135 (discussed further below) extend through the day manipulation aperture 134 as shown. This configuration allows access to manipulate the day manipulation disk 135 with a user's finger. Referring to FIG. 4, a front-second side perspective view of the medication tracking apparatus 100 is shown. In this view, an AM/PM aperture 107 in a second side of the side edge of the housing 102 is shown. A manipulation portion 109a of an AM/PM indicator member 109 (discussed below) extends out of the AM/PM aperture. This configuration allows access to manipulate the AM/PM indicator member 109 by a user's finger. FIG. 5 illustrates a back perspective view of the medication tracking apparatus 100. In this embodiment, an adhesive 138 is coupled to the back side of the medication tracking apparatus 100. The adhesive 138 allows the user to physically attach the medication tracking apparatus 100 to a medication holding container or the like. Further, this embodiment includes a backing 139 that is peeled off the adhesive 138 when the medication tracking apparatus 100 is attached to the medication holding device 100. In one embodiment, the adhesive 138 includes a cushion portion. Moreover, other methods of attaching the medication holding device 100 are contemplated, such as adapting the housing 102 to be snap fitted on a cap of a medication holding bottle. Hence the present invention is not limited to the use of an adhesive. Moreover, in one embodiment, the adhesive used allows for multiple attachments and un-attachments so the medication tracking assembly 100 can be used over and over again. In still yet another embodiment the medication tracking assembly 100 is integral with a cap 60. That is, in this embodiment the medication tacking assembly 100 is formed into (part of) the cap 60 that is used for a medication holding bottle 50.

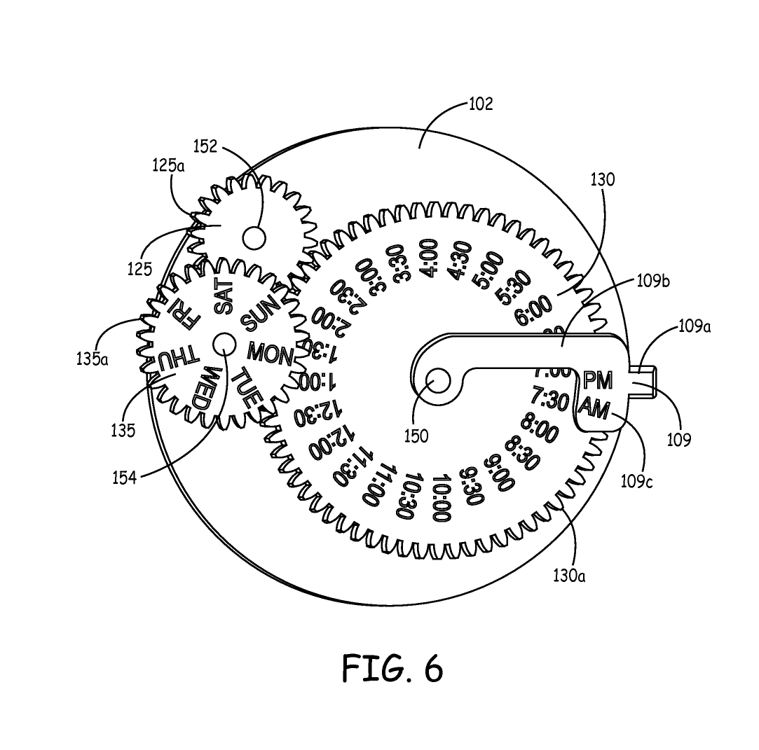

FIG. 6 illustrates a front view of the medication tracking assembly 100 with part of the housing 102 removed so the internal components are shown. As illustrated, the medication tracking assembly 100 includes the day manipulation disk 135. The day manipulation disk 135 is pivotally coupled to a day connection pivot post 154 which in turn is coupled to the housing 102. As illustrated, all of the days of the week (day information) are marked on the day manipulation disk 135. The user simply rotates the day manipulation disk 135 about the day connection pivot post 154 by engaging the day manipulation teeth 135a until a desired day is shown in the day window 112. Also illustrated in FIG. 6, is the time manipulation disk 125. The time manipulation disk 125 is pivotally coupled to a time manipulation pivot post 152 which in turn is coupled to the housing 102. Time manipulation teeth 125a of the time manipulation disk 125 engage time display teeth 130a on a time display disk 130. The time display disk 130 is pivotally coupled to a time display pivot post 150 which in turn is coupled to the housing 102. Engagement of the time manipulation teeth 125a of the time manipulation disk 125 through the time manipulation aperture 124 rotates the time manipulation disk 125. The time manipulation disk 125 in turn rotates the time display disk 130 to selectively display a time through the time window 114. The AM/PM indicator member 109 includes the manipulation portion 109a, an arm portion 109b and a display portion 109c. The display portion 109c is positioned between the arm portion 109b and the manipulation portion 109a. One end of the arm portion 109b is rotationally couple to a time display post 150 which in turn is coupled to the housing 102. The other end of the arm portion 109b extends into the display portion 109c. The user simply engages the manipulation portion 109a of the AM/PM indicator member 109 to move the desired “AM” or “PM” marking on the display portion 109c in the AM/PM window 110 of the housing 102.

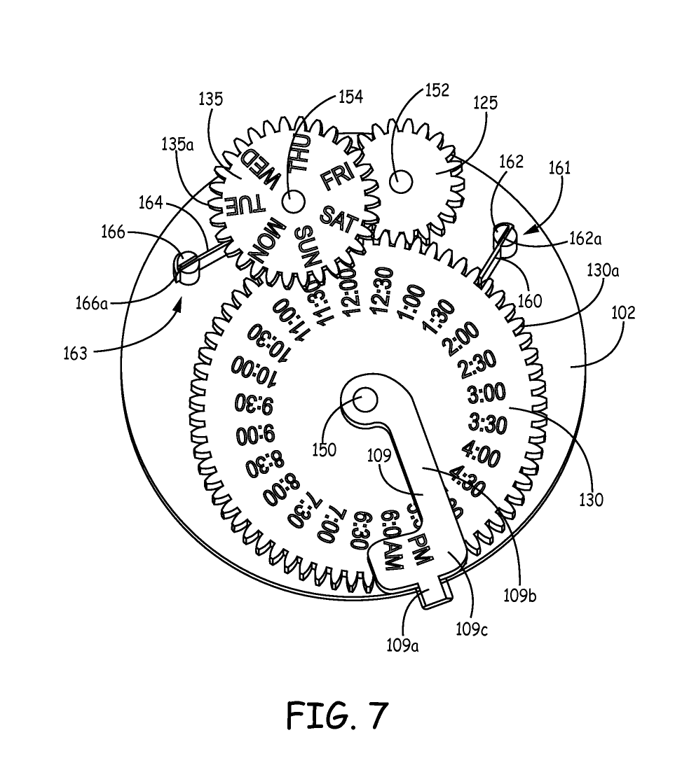

Referring to FIG. 7, a front view of the medication tracking assembly 100 with part of the housing 102 removed of an embodiment is illustrated. FIG. 7 illustrates a time position holding assembly 161 and a day position holding assembly 163 designed to hold the respective day manipulation disk 135 and time manipulation disk 130 in static positions in relation to the housing 102. In particular, the day position holding assembly 163 includes a day holding pin 166 coupled to the housing 102 and a pliable day holding member 164. The day holding pin 166 holds a first end of the day holding member 164 in a day holding slot 166a. A second end of the day holding member 164 fits between a pair of adjacent day manipulation teeth 135a of the day manipulation disk 135 to hold the day manipulation disk 135 in a static position in relation to the housing 102 and the day window 112 of the housing 102. Since the day holding member 164 is pliable (or flexible), when enough force is applied by the user on the day manipulation teeth 135a, engagement of the second end of the day holding member 164 on a day manipulation tooth 135a bends the second end of the day holding member 164 to allow the day manipulation disk 135 to rotate. Resilient properties of the day holding member 164 cause the second end of the day holding member 164 to return to its unbent configuration when one of the day manipulation teeth 135a is no longer engaged. Hence, the configuration of the day holding assembly 163 prevents the day manipulation disk 135 from rotating inadvertently once a select day is selected in the day window 112. Similarly, a pliable time holding member 160 of the time position holding assembly 161 is used to prevent inadvertent movement of the time display disk 130. In particular, a first end of the time holding member 160 is held within a time holding slot 162a in a time holding pin 162. The time holding pin is coupled to the housing 102. A second end of the time holding member 160 fits between an adjacent pair of time display teeth 130a of the time display disk 130 to hold the time display disk 130 in a static position in relation to the housing and the time display window 114. To move the time display disk 130 the user simply applies a select force to rotate the time manipulation disk 125 which in turn rotates the time display disk 130. The select force bends the second end of the time holding member 160 to allow movement of the time display disk 130. Resilient properties of the time holding member 160 causes the second end of the time holding member 160 to return to its unbent configuration when one of the time display teeth 130 is no longer engaged. In the unbent configuration, the second end of the time holding member 160 fits between an adjacent pair of time display teeth 130a of the time display disk 130 to hold the time display disk 130 in a static position as discussed above.

In use, in one embodiment, once the user had taken an associated medication, the user simply engages the day manipulation teeth 135a of the day manipulation disk 135 to select the desired day to be displayed in the day window 112 of the housing. The user also engages the time manipulation teeth 125a of the time manipulation disk 125 to select the desired time to be displayed in the time window 114 of the housing. The corresponding AM/PM to the time is then selected by engaging the manipulation portion 109a of AM/PM indicator member 109. To aid viewing by the user, in some embodiments each window 112, 114 and 110 includes magnifying lens, or the like, to increase the size of the markings that sets out the day, time and AM/PM settings.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A medication tracking apparatus, comprising:
a housing having at least one window;
a day manipulation disk having day information rotationally coupled within the housing, the day manipulation disk further configured and arranged to be manually rotated to display a select day from the day information in the at least one window of the housing; and
a time display disk with time information rotationally coupled within the housing, the time display disk further configured and arranged to be manually rotated to display a select time from the time information in the at least one window of the housing.

2. The medication tracking apparatus of claim 1, further comprising:
an adhesive to couple the housing to a medication holding device.

3. The medication tracking apparatus of claim 1, further comprising:
a time manipulation disk engaged to rotate the time display disk.

4. The medication tracking apparatus of claim 1, further comprising:
the housing including “Last” and “Taken” markings.

5. The medication tracking apparatus of claim 1, further comprising:
the housing having an AM/PM window.

6. The medication tracking apparatus of claim 5, further comprising:
an AM/PM indicator member rotationally coupled to the housing to selectively display “AM” and “PM” markings in the AM/PM window.

7. The medication tracking apparatus of claim 6, wherein the AM/PM indicator member further comprises:
an arm portion, a first end of the arm portion pivotally coupled to the housing;
a display portion extending from the arm portion, the display portion including the “AM” and “PM” markings; and
a manipulation portion extending from the display portion, the manipulation portion of the AM/PM indicator member extending out of an AM/PM aperture in the housing.

8. The medication tracking apparatus of claim 1, further comprising:
at least one magnifying lens positioned to magnify the at least one window.

9. The medication tracking apparatus of claim 1, wherein the housing further having a time manipulation aperture that provides access to manipulate the time display disk.

10. The medication tracking device apparatus of claim 1, wherein the housing having a day manipulation aperture that provides access to manipulate the day manipulation disk.

11. The medication tracking device apparatus of claim 1, further comprising:
a time position holding assembly to selectively hold the time display disk in a static position in relation to the housing; and
a day position holding assembly to selectively hold the day display disk in a static position in relation to the housing.

12. The medication tracking device apparatus of claim 11, further comprising:
the time position holding assembly including a time holding pin and a pliable time holding member, the time holding pin being coupled to the housing, the time holding pin further including a time slot, the pliable time holding member having a first end held within the time slot of the time holding pin and a second end positioned to selectively engage the time display disk: and
the day position holding assembly including a day holding pin and a pliable day holding member, the day holding pin being coupled to the housing, the day holding pin further including a day slot, the pliable day holding member having a first end held within the day slot of the day holding pin and a second end positioned to selectively engage the day display disk.

13. A medication tracking apparatus comprising:
a housing being generally disk shaped having a front side, a back side and a side edge, the housing having a day window and a time window through the front side, the housing further including a day manipulation aperture and a time manipulation aperture through the side edge of housing;
a day manipulation disk received within the housing, the day manipulation disk including day information selectively displayed through the day window, the day manipulation aperture allowing access to manipulate the day manipulation disk; and
a time display disk received within the housing, the time display disk including day information selectively displayed through the time window, the time manipulation aperture allowing access to manipulate the time manipulation disk.

14. The medication tracking apparatus of claim 13, further comprising:
a time manipulation disk engaging the time display disk, part of the time manipulation disk extending out of the time manipulation aperture in the housing.

15. The medication tracking device apparatus of claim 13, further comprising:
a time position holding assembly to selectively hold the time display disk in a static position in relation to the housing; and
a day position holding assembly to selectively hold the day display disk in a static position in relation to the housing.

16. The medication tracking device apparatus of claim 15, further comprising:
the time position holding assembly including a time holding pin and a pliable time holding member, the time holding pin being coupled to the housing, the time holding pin further including a time slot, the pliable time holding member having a first end held within the time slot of the time holding pin and a second end positioned to selectively engage time teeth of the time display disk; and
the day position holding assembly including a day holding pin and a pliable day holding member, the day holding pin being coupled to the housing, the day holding pin further including a day slot, the pliable day holding member having a first end held within the day slot of the day holding pin and a second end positioned to selectively engage day teeth of the day display disk.

17. The medication tracking device apparatus of claim 13, further comprising:
the housing having an AM/PM window; and
an AM/PM indicator member rotationally coupled to the housing to selectively display “AM” and “PM” markings in the AM/PM window.

18. A medication tracking apparatus comprising:
a housing being generally disk shaped having a front side, a back side and a side edge, the housing having a day window and a time window through the front side, the housing further including a day manipulation aperture and a time manipulation aperture through the side edge of housing;
a day manipulation disk received within the housing, the day manipulation disk including day information selectively displayed through the day window, the day manipulation aperture allowing access to manipulate the day manipulation disk by a user;
a time display disk received within the housing, the time display disk including day information selectively displayed through the time window, the time manipulation aperture allowing access to manipulate the time manipulation disk by the user;
a time position holding assembly configured and arranged to hold the time display disk in a static position in relation to the housing when the time display disk is not being manipulated by the user; and
a day position holding assembly configured and arranged to hold the day manipulation disk in a static position in relation to the housing when the day manipulation disk is not being manipulated by the user.

19. The medication tracking apparatus of claim 18 further comprising:
the time position holding assembly including a time holding pin and a pliable time holding member, the time holding pin being coupled to the housing, the time holding pin further including a time slot, the pliable time holding member having a first end held within the time slot of the time holding pin and a second end positioned to selectively engage time teeth of the time display disk: and
the day position holding assembly including a day holding pin and a pliable day holding member, the day holding pin being coupled to the housing, the day holding pin further including a day slot, the pliable day holding member having a first end held within the day slot of the day holding pin and a second end positioned to selectively engage day teeth of the day display disk.

20. The medication tracking apparatus of claim 18, wherein the housing is part of a cap for a medication holding bottle.
